(19) United States
(12) Patent Application Publication
(10) Pub. No.: US 2019/0362004 A1
(43) Pub. Date: Nov. 28, 2019

(54) DATA PLATFORM FABRIC

(71) Applicant: MICROSOFT TECHNOLOGY LICENSING, LLC, Redmond, WA (US)

(72) Inventors: Stanislav A. Oks, Kirkland, WA (US); Travis Austin Wright, Issaquah, WA (US); Michael Edward Nelson, Redmond, WA (US); Pranjal Gupta, Bellevue, WA (US); Scott Anthony Konersmann, Monroe, WA (US)

(21) Appl. No.: 16/169,920

(22) Filed: Oct. 24, 2018

Related U.S. Application Data
(60) Provisional application No. 62/675,555, filed on May 23, 2018.

(51) Int. Cl. G06F 17/30; G06F 9/50; G06F 9/54

(52) U.S. Cl. CPC G06F 17/30404; G06F 9/54; G06F 9/5011; G06F 17/30312

(57) ABSTRACT

Automatically provisioning resources within a database system includes receiving, at a master service of the database system, a declarative statement for performing a database operation. Based on receiving the declarative statement, a control plane is instructed that additional hardware resources are needed for performing the database operation. Based on instructing the control plane, a provisioning fabric provisions computer system hardware resources for one or more of (i) a storage pool that includes at least one storage node that comprises a first database engine, a big data engine, and big data storage; (ii) a data pool that includes at least one data node that comprises a second database engine and database storage; or (iii) a compute pool that includes a compute node that comprises a compute engine that processes queries at one or both of the storage pool or the data pool.

### CROSS-REFERENCE TO RELATED APPLICATION

This application claims priority to, and the benefit of, U.S. Provisional Patent Application No. 62/675,555, filed May 23, 2018, and titled “MANAGED DATABASE CONTAINERS ACROSS CLOUDS,” the entire contents of which are incorporated by reference herein in their entirety.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. For example, computer systems are commonly used to store and process large volumes of data using different forms of databases.

Databases can come in many forms. For example, one family of databases follow a relational model. In general, data in a relational database is organized into one or more tables (or “relations”) of columns and rows, with a unique key identifying each row. Rows are frequently referred to as records or tuples, and columns are frequently referred to as attributes. In relational databases, each table has an associated schema that represents the fixed attributes and data types that the items in the table will have. Virtually all relational database systems use variations of the Structured Query Language (SQL) for querying and maintaining the database. Software that parses and processes SQL is generally known as an SQL engine. There are a great number of popular relational database engines (e.g., MICROSOFT SQL SERVER, ORACLE, MYSQL POSTGRESQL, DB2, etc.) and SQL dialects (e.g., T-SQL, PL/SQL, SQL/PSM, PL/PGSQL, SQL PL, etc.).

Databases can also come in non-relational (also referred to as “NoSQL”) forms. While relational databases enforce schemas that define how all data inserted into the database must be typed and composed, many non-relational databases can be schema agnostic, allowing unstructured and semi-structured data to be stored and manipulated. This can provide flexibility and speed that can be difficult to achieve with relational databases. Non-relational databases can come in many forms, such as key-value stores (e.g., REDIS, AMAZON DYNAMODB), wide column stores (e.g., CASSANDRA, SCYLLA), document stores (e.g., MONGODB, COUCHBASE), etc.

The proliferation of the Internet and of vast numbers of network-connected devices has resulted in the generation and storage of data on a scale never before seen. This has been particularly precipitated by the widespread adoption of social networking platforms, smartphones, wearables, and Internet of Things (IoT) devices. These services and devices tend to have the common characteristic of generating a nearly constant stream of data, whether that be due to user input and user interactions, or due to data obtained by physical sensors. This unprecedented generation of data has opened the doors to entirely new opportunities for processing and analyzing vast quantities of data, and to observe data patterns on even a global scale. The field of gathering and maintaining such large data sets, including the analysis thereof, is commonly referred to as “big data.”

In general, the term “big data” refers to data sets that are voluminous and/or are not conducive to being stored in rows and columns. For instance, such data sets often comprise blobs of data like audio and/or video files, documents, and other types of unstructured data. Even when structured, big data frequently has an evolving or jagged schema. Traditional databases (both relational and non-relational alike), may be inadequate or sub-optimal for dealing with “big data” data sets due to their size and/or evolving/jagged schemas.

As such, new families of databases and tools have arisen for addressing the challenges of storing and processing big data. For example, APACHE HADOOP is a collection of software utilities for solving problems involving massive amounts of data and computation. HADOOP includes a storage part, known as the HADOOP Distributed File System (HDFS), as well as a processing part that uses new types of programming models, such as MapReduce, Tez, Spark, Impala, Kudu, etc.

The HDFS stores large and/or numerous files (often totaling gigabytes to petabytes in size) across multiple machines. The HDFS typically stores data that is unstructured or only semi-structured. For example, the HDFS may store plaintext files, Comma-Separated Values (CSV) files, JavaScript Object Notation (JSON) files, Avro files, Sequence files, Record Columnar (RC) files, Optimized RC (ORC) files, Parquet files, etc. Many of these formats store data in a columnar format, and some feature additional metadata and/or compression.

As mentioned, big data processing systems introduce new programming models, such as MapReduce. A MapReduce program includes a map procedure, which performs filtering and sorting (e.g., sorting students by first name into queues, one queue for each name), and a reduce method, which performs a summary operation (e.g., counting the number of students in each queue, yielding name frequencies). Systems that process MapReduce programs generally leverage multiple computers to run these various tasks in parallel and manage communications and data transfers between the various parts of the system. An example engine for performing MapReduce functions is HADOOP YARN (Yet Another Resource Negotiator).

Data in HDFS is commonly interacted with/managed using APACHE SPARK, which provides Application Programming Interfaces (APIs) for executing “jobs” which can manipulate the data (insert, update, delete) or query the data. At its core, SPARK provides distributed task dispatching, scheduling, and basic input/output functionalities, exposed through APIs for interacting with external programming languages, such as Java, Python, Scala, and R.

Given the maturity of, and existing investment in database technology many organizations may desire to process/analyze big data using their existing relational and/or non-relational database systems (DBMSs), leveraging existing tools and know-how. However, this may involve a manual process of provisioning and maintaining physical hardware or virtual resources for both DBMSs and big data systems, installing and configuring the systems' respective software, and propagating data between the two systems. This also presents security and privacy challenges since security and privacy settings and policies are managed separately by each system.

### BRIEF SUMMARY

Embodiments described herein automate the deployment and management of pools of nodes within database systems. These pools can include, for example, compute pools comprising compute nodes, storage pools comprising storage nodes, and/or data pools comprising data nodes. In embodiments, compute pools can be used to scale-out database system compute capacity, storage pools can be used to incorporate big data systems (e.g., HDFS storage and SPARK query capability) into the database system and scale out big data storage capacity, and data pools can be used to scale-out traditional database storage capacity (e.g., relational and/or non-relational storage).

As such, depending on which pools are present, at least some embodiments described herein incorporate, within the unified database system, both traditional DBMSs (e.g., e.g., traditional relational or non-relational DBMSs) and big data database systems (e.g., APACHE HADOOP). Such embodiments thus enable centralized and integrated management of both traditional DMB Ss and emerging big data systems and, make growing and shrinking compute and storage resources transparent to database system consumers.

This unified database system can be extended to multiple database clusters/containers within the same cloud, and/or can be extended across multiple clouds (both public and private). When extended across clouds, a single control plane can be used to manage the entire system, greatly simplifying unified database system management, and consolidating the management of security and privacy policies.

In some embodiments, systems, methods, and computer program products for automatically provisioning resources within a database system include receiving, at a master service of the database system, a declarative statement for performing a database operation. Based on receiving the declarative statement, a control plane is instructed that additional hardware resources are needed for performing the database operation. Based on instructing the control plane, a provisioning fabric provisions computer system hardware resources for one or more of: (i) a storage pool that includes at least one storage node that comprises a first database engine, a big data engine, and big data storage (ii) a data pool that includes at least one data node that comprises a second database engine and database storage, or (iii) a compute pool that includes a compute node that comprises a compute engine that processes queries at one or both of the storage pool or the data pool.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a unified database system that provides integration and automated deployment and management of traditional DBMSs and big data systems;

FIG. 2 illustrates an example database system that demonstrates plural master services and replicated master services;

FIG. 3 illustrates an environment that manages multiple database systems across multiple clouds; and

FIG. 4 illustrates a flow chart of an example method for automatically provisioning resources within a database system.

### DETAILED DESCRIPTION

Embodiments described herein automate the deployment and management of pools of nodes within database systems. These pools can include, for example, compute pools comprising compute nodes, storage pools comprising storage nodes, and/or data pools comprising data nodes. In embodiments, compute pools can be used to scale-out database system compute capacity, storage pools can be used to incorporate big data systems (e.g., HDFS storage and SPARK query capability) into the database system and scale out big data storage capacity, and data pools can be used to scale-out traditional database storage capacity (e.g., relational and/or non-relational storage).

As such, depending on which pools are present, at least some embodiments described herein incorporate, within the unified database system, both traditional DBMSs (e.g., e.g., traditional relational or non-relational DBMSs) and big data database systems (e.g., APACHE HADOOP). Such embodiments thus enable centralized and integrated management of both traditional DMB Ss and emerging big data systems and, make growing and shrinking compute and storage resources transparent to database system consumers.

This unified database system can be extended to multiple database clusters/containers within the same cloud, and/or can be extended across multiple clouds (both public and private). When extended across clouds, a single control plane can be used to manage the entire system, greatly simplifying unified database system management, and consolidating the management of security and privacy policies.

As will be appreciated in view of the disclosure herein, the embodiments described represent significant advancements in the technical fields of database deployment and management. For example, by automating the provisioning and deprovisioning of hardware resources to various pools and nodes the embodiments herein can ensure that hardware resources are efficiently allocated where they are needed in order to meet current query processing demands. As another example, by providing for storage, compute, and data pools, the embodiments herein enable database scale out functionality that has not been available before. As yet another example, by supporting big data engines and big data storage (i.e., in storage pools) as well as traditional database engines, the embodiments herein bring traditional database functionality together with big data functionality within a single managed system for the first time, reducing the number of computer systems that need to be deployed and managed and providing for queries over the combination of traditional and big data that were not possible prior to these innovations.

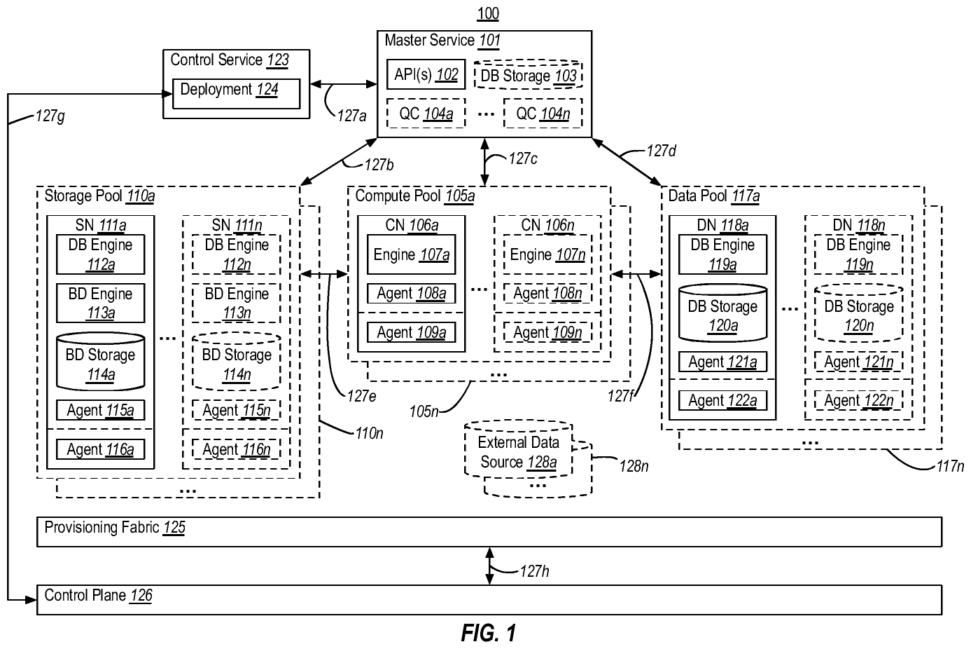

FIG. 1 illustrates an example of a unified database system 100 that provides integration and automated deployment and management of traditional DBMSs and big data systems. As shown, database system 100 includes a master service 101. The master service 101 is an endpoint that manages interaction of the database system 100 with external consumers (e.g., other computer systems, software products, etc., not shown) by providing API(s) 102 to receive and reply to queries (e.g., SQL queries, NoSQL queries, etc.). As such, master service 101 can initiate processing of queries received from consumers using other elements of database system 100 (i.e., compute pool(s) 105, storage pool(s) 110, and/or data pool(s) 117, which are described later). Based on obtaining results of processing of queries, the master service 101 can send results back to requesting consumer(s).

In some embodiments, master service 101 could appear to external consumers to be a traditional DBMS (e.g., a typical relational or non-relational DBMS of which the external consumers are familiar). Thus, API(s) 102 could be configured to receive and respond to traditional DBMS queries. In these embodiments, the master service 101 could include a traditional DBMS engine. However, in addition, master service 101 might also facilitate big data queries (e.g., SPARK or MapReduce jobs). Thus, API(s) 102 could also be configured to receive and respond to big data queries. In these embodiments, the master service 101 could also include a big data engine (e.g., a SPARK engine). Regardless of whether master service 101 receives a traditional DBMS query or a big data query, the master service 101 is enabled to process that query over a combination of traditional DBMS data and big data. While database system 100 provides expandable locations for storing DBMS data (e.g., in data pools 117, as discussed below), it is also possible that master service 101 could include its own database storage 103 as well (e.g., for storing traditional relational or non-relational data).

As shown, database system 100 can include one or more compute pools 105 (shown as 105a-105n). If present, each compute pool 105 includes one or more compute nodes 106 (shown as 106a-106n). The ellipses within compute pool 105a indicate that each compute pool 105 could include any number of compute nodes 106 (i.e., one or more compute nodes 106). Each compute node can, in turn, include a corresponding compute engine 107a (shown as 107a-107n).

If one or more compute pools 105 are included in database system 100, the master service 101 can pass a query received at API(s) 102 to at least one compute pool 105 (e.g., arrow 127c). That compute pool (e.g., 105a) can then use one or more of its compute nodes (e.g., 106a-106n) to process the query against storage pools 110 and/or data pools 117 (e.g., arrows 127e and 1270. These compute node(s) 106 process this query using their respective compute engine 107. After the compute node(s) 106 complete processing of the query, the selected compute pool(s) 105 pass any results back to the master service 101.

By including compute pools 105, the database system 100 can enable query processing capacity to be scaled up efficiently (i.e., by adding new compute pools 105 and/or adding new compute nodes 106 to existing compute pools). The database system 100 can also enable query processing capacity to be scaled back efficiently (i.e., by removing existing compute pools 105 and/or removing existing compute nodes 106 from existing compute pools).

In embodiments, if the database system 100 lacks compute pool(s) 105, then the master service 101 may itself handle query processing against storage pool(s) 110, data pool(s) 117, and/or its local database storage 103 (e.g., arrows 127b and 127d). In embodiments, if one or more compute pools 105 are included in database system 100, these compute pool(s) could be exposed to an external consumer directly. In these situations, that external consumer might bypass the master service 101 altogether, and initiate queries on those compute pool(s) directly.

As shown, database system 100 can also include one or more storage pools 110 (shown as 110a-110n). If present, each storage pool 110 includes one or more storage nodes 111 (shown as 111a-111n). The ellipses within storage pool 110a indicate that each storage pool could include any number of storage nodes (i.e., one or more storage nodes).

As shown, each storage node 111 includes a corresponding database engine 112 (shown as 112a-112n), a corresponding big data engine 113 (shown as 113a-113n), and corresponding big data storage 114 (shown as 114a-114n). For example, the database engine 112 could be a traditional relational (e.g., SQL) or non-relational (e.g., No-SQL) engine, the big data engine 113 could be a SPARK engine, and the big data storage 114 could be HDFS storage. Since storage nodes 111 include big data storage 114, data are stored at storage nodes 111 using “big data” file formats (e.g., CSV, JSON, etc.), rather than more traditional relational or non-relational database formats.

Notably, however, storage nodes 111 in each storage pool 110 include both a database engine 112 and a big data engine 113. These engines 112, 113 can be used—singly or in combination—to process queries against big data storage 114 using traditional database queries (e.g., SQL queries) and/or using big data queries (e.g., SPARK queries). Thus, the storage pools 110 allow big data to be natively queried with a DBMS's native syntax (e.g., SQL), rather than requiring use of big data query formats (e.g., SPARK). For example, storage pools 110 could permit queries over data stored in HDFS-formatted big data storage 114, using SQL queries that are native to a relational DBMS. This means that database system 100 can make big data analysis readily accessible to a broad range of DBMS administrators/developers.

As shown, database system 100 can also include one or more data pools 117 (shown as 117a-117n). If present, each data pool 117 includes one or more data nodes 118 (shown as 118a-118n). The ellipses within data pool 117a indicate that each data pool could include any number of data nodes (i.e., one or more data nodes).

As shown, each data node 118 includes a corresponding database engine 119 (shown as 119a-119n) and corresponding database storage 120 (shown as 120a-120n). In embodiments, the database engine 119 could be a traditional relational (e.g., SQL) or non-relational (e.g., No-SQL) engine and the database storage 120 could be a traditional native DBMS storage format. Thus, data pools 117 can be used to store and query traditional database data stores, where the data is partitioned across individual database storage 120 within each data node 118.

By supporting the creation and use of storage pools 110 and data pools 117, the database system 100 can enable data storage capacity to be scaled up efficiently, both in terms of big data storage capacity and traditional database storage capacity (i.e., by adding new storage pools 110 and/or nodes 111, and/or by adding new data pools 117 and/or nodes 118). The database system 100 can also enable data storage capacity to be scaled back efficiently (i.e., by removing existing storage pools 110 and/or nodes 111, and/or by removing existing data pools 117 and/or nodes 118).

Using the database storage 103, storage pools 110, and/or data pools 117, the master service 101 might be able to process a query (whether that be a traditional DBMS query or a big data query) over a combination of traditional DBMS data and big data. Thus, for example, a single query can be processed over any combination of (i) traditional DBMS data stored at the master service 101 in database storage 103, (ii) big data stored in big data storage 114 at one or more storage pools 110, and (iii) traditional DBMS data stored in database storage 120 at one or more data pools 117. This may be accomplished, for example, by the master service 110 creating an “external” table over any data stored at database storage 103, big data storage 114, and/or database storage 120. An external table is a logical table that represents a view of data stored in these locations. A single query, sometimes referred to as a global query, can then be processed against a combination of external tables.

In some embodiments, the master service 101 can translate received queries into different query syntaxes. For example, FIG. 1 shows that in the master service 101 might include one or more query converters 104 (shown as 104a-104n). These query converters 104 can enable the master service 101 to interoperate with database engines having a different syntax than API(s) 102. For example, the database system 100 might be enabled to interoperate with one or more external data sources 128 (shown as 128a-128n) that could use a different query syntax than API(s) 102. In this situation, the query converters 104 could receive queries targeted at one or more of those external data sources 128 in one syntax (e.g., T-SQL), and could convert those queries into syntax appropriate to the external data sources 128 (e.g., PL/SQL, SQL/PSM, PL/PGSQL, SQL PL, REST API, etc.). The master service 101 could then query the external data sources 128 using the translated query. It might even be possible that the storage pools 110 and/or the data pools 117 include one or more engines (e.g., 112, 113, 119) that use a different query syntax than API(s) 102. In these situations, query converters 104 can convert incoming queries into appropriate syntax for these engines prior to the master service 101 initiating a query on these engines. Database system 100 might, therefore, be viewed as a “poly-data source” since it is able to “speak” multiple data source languages. Notably, use of query converters 104 can provide flexible extensibility of database system 100, since it can be extended to use new data sources without the need to rewrite or otherwise customize those data sources.

The database system 100 can be configured to automatically create/destroy the various nodes/pools that are shown in FIG. 1, as needed, based on requests received at the master service 101 (e.g., declarative statements in the form of SQL queries). In embodiments, these “scale up” and “scale down” operations could be performed dynamically based on the expected demand of a query or multiple queries. This automatic scaling could be performed in variety of manners. For example, the database system 100 could predict an amount of compute resources required by a query or queries based on statistics from executing prior queries. In another example, the database system 100 could leverage machine learning model that predicts the capacity demand for performing the query/queries.

In order to facilitate automated creation and destruction of storage and compute resources, FIG. 1 shows that implementations of the database system 100 could include a control service 123. As shown by arrow 127a, in these implementations the master service 101 can be configured for communication with this control service 123. The control service 123 can, in turn, include a deployment module 124 that controls the creation and destruction of storage and compute resources. As shown by arrow 127g, the deployment module 124 can communicate with a control plane 126 which, in turn, can communicate with a provisioning fabric 125 (i.e., arrow 127h). However, in other implementations, the master service 101 could communicate with the control plane 126 and/or provisioning fabric 125 directly.

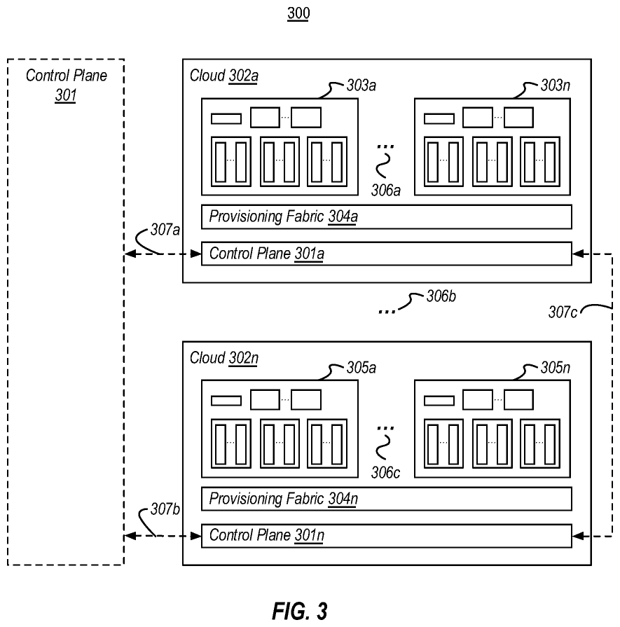

In implementations, the control plane 126 is responsible for monitoring and management of database system 100, including managing provisioning with the provisioning fabric 125, performing backups, ensuring sufficient nodes exist for high-availability and failover, performing logging and alerting, and the like. With respect to provisioning, the control plane 126 can send provisioning instructions to the provisioning fabric 125. These provisioning instructions could include such operations as provision, deprovision, upgrade, change configuration, etc. Change configuration instructions could include such things as scaling up or scaling down a pool, changing allocations of physical resources (e.g., processors, memory, etc.) to nodes, moving nodes to different physical computer systems, etc. While control plane 126 is shown as managing database system 100, control plane 126 could also be part of a larger control infrastructure that manages plural database systems within a cloud or across multiple clouds. These embodiments are discussed in greater detail later in connection with FIG. 3.

In embodiments, based on instructions from the control plane 126, the provisioning fabric 125 manages physical resources available to database system 100 and is able to provision and destroy these resources, as needed. Resources could be provisioned in the form of virtual machines, containers, jails, or other types of dynamically-deployable resources. For simplicity, the description herein uses the term “container” to refer to these deployed resources generally, and includes use of virtual machines, jails, etc. In some embodiments, the provisioning fabric 125 could be based on the KUBERNETES container management system, which operates over a range of container tools, including DOCKER and CONTAINERD. To external consumers, operation of the deployment module 124 and the provisioning fabric 125 could be entirely transparent. As such, the database system 100 could obfuscate creation and destruction of compute resources and pools, such that, to external consumers, the database system 100 appears as a single database.

The following examples provide a few illustrations of operation of the deployment module 124 and the provisioning fabric 125. In a first example, in response to declarative statement(s) received by the master service 101 that create one or more database table(s), the master service 101 could request that the deployment module 124 instruct the provisioning fabric 125 (i.e., via control plane 126) to create and provision new database resources as new data nodes 118 within a data pool 117, or within entirely new data pool(s) 117. The master service 101 can than initiate creation of these tables within the newly-provisioned storage resources. If these database tables are later dropped, the deployment module 124 could automatically instruct the provisioning fabric 125 to destroy these database resources.

In another example, in response to declarative statement(s) received by the master service 101 that import big data, the master service 101 could request that the deployment module 124 instruct the provisioning fabric 125 (i.e., via control plane 126) to create and provision new storage resources as new storage nodes 111 within an existing storage pool 110, or within entirely new storage pool(s) 110. The master service 101 can than initiate storage of this new big data within the newly-provisioned storage resources. If this big data is later deleted, the deployment module 124 could automatically instruct the provisioning fabric 125 to destroy these storage resources.

In yet another example, in response to one or more queries received by the master service 101 that will consume a large amount of computational resources, the master service 101 could request that the deployment module 124 instruct the provisioning fabric 125 (i.e., via control plane 126) to create and provision new compute resources as new compute nodes 106 within an existing compute pool 105 or could create entirely compute pool(s) 105. The master service 101 can then initiate processing of these queries using these newly-provisioned compute resources. When the queries complete, the deployment module 124 could automatically instruct the provisioning fabric 125 to destroy these new compute resources.

The individual nodes created within database system 100 can include corresponding agents that communicate with one or more of the provisioning fabric 125, the control plane 126, and/or the control service 123. For example, storage nodes 111 can include agents 115 (shown as 115a-115n) and 116 (shown as 116a-116n), compute nodes 105 can include agents 108 (shown as 108a-108n) and 109 (shown as 109a-109n), and data nodes 118 can include agents 121 (shown as 121a-121n) and 122 (shown as 122a-122n). Although not expressly depicted, even the master service 101 could be implemented as a node provisioned by the provisioning fabric 125 and could therefore include its own corresponding agents.

As shown, each provisioned node includes at least two domains, separated in FIG. 1 by a broken line. The top portion (including software agents 115, 108, and 121) represent a “node-level” domain for the node (e.g., a service level domain). The bottom portion (including software host agents 116, 109, and 112) represent a “node host-level” domain for the node (e.g., a domain corresponding to the container that hosts the node's services). In embodiments, the agents communicate with the control plane 126 e.g., to receive instructions from the control plane 126 and to provide reports to the control plane 126.

The agents in each domain are responsible for monitoring and actions within their respective domain. For example, agents 115, 108, and 121 might be responsible for managing and monitoring operation of the services (e.g., engines) running within their respective node, and providing reports to the control plane 126. This could include, for example, handling crashes of these engines. Agents 115, 108, and 121 might also be responsible for initiating failures of these engines as part of testing resiliency of the overall database system 100. Agents 116, 109, and 112, on the other hand, might be responsible for managing and monitoring operation of the node host hosting the database system nodes, including collecting logs, crash dumps, and the like and providing reports to control plane 126; setting watchdog timers and performing health checks; performing configuration changes and rollovers (e.g., certificate rotation); dealing with hardware failures; gathering performance and usage data; etc.

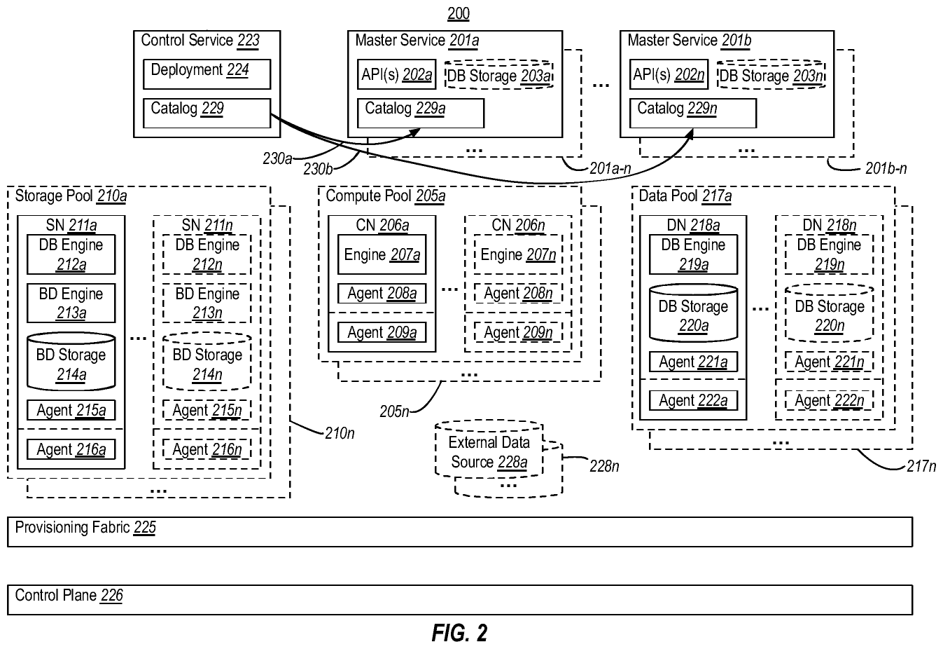

FIG. 2 illustrates an example database system 200 that is similar to the database system 100 of FIG. 1, but which demonstrates plural master services and replicated master services. The numerals (and their corresponding elements) in FIG. 2 correspond to similar numerals (and corresponding elements) from FIG. 1. For example, compute pool 205a corresponds to compute pool 105a, storage pool 210a corresponds to storage pool 110a, and so on. As such, all of the description of database system 100 of FIG. 1 applies to database system 200 of FIG. 2. Likewise, all of the additional description of database system 200 of FIG. 2 could be applied to database system 100 of FIG. 1.

Notably, however, database system 100 shows a single master service 101, while database system 200 includes a plurality of master services 201 (shown as 201a-201n). As shown, each master service 201 can include a corresponding set of API(s) 202 (shown as 202a-202n) and can potentially include corresponding database storage 203 (shown as 203a-203n).

In embodiments, each of these master services might serve a different vertical. For example, if database system 200 is deployed by a single organization, master service 201a might service requests from external consumers of a first organizational department (e.g., an accounting department), while master service 201b services requests from external consumers of a second organizational department (e.g., a sales department). Additionally, or alternatively, master service 201a might service requests from external consumers within a first geographical region (e.g., one field office of an organization), while master service 201b services from external consumers within a second geographical region (e.g., another field office of an organization). In another example, if database system 200 is deployed by a hosting service (e.g., a cloud services provider), master service 201a might service requests from external consumers of a first tenant (e.g., a first business entity), while master service 201b services requests from external consumers of a second tenant (e.g., a second business entity). The possibilities of how different verticals could be defined are essentially limitless.

Use of plural master services 201 can create a number of advantages. For example, use different master services 201 for different verticals can provide isolation between verticals (e.g., in terms of users, data, etc.) and can enable each vertical to implement different policies (e.g., privacy, data retention, etc.). In another example, much like the various pools, use of plural master services 201 can enable scale-out of the master service itself. In another example, use of plural master services 201 can enable different master services 201 to provide customized API(s) to external consumers. For example, API(s) 202a provided by master service 201a could communicate in a first SQL dialect, while API(s) 202b provided by master service 201b could communicate in a second SQL dialect—thereby enabling external consumers in each vertical to communicate in the dialect(s) for which they are accustomed.

As was mentioned in connection with FIG. 1, master service 101 might be implemented on a container that is provisioned by the provisioning fabric 125. Likewise, master services 201 could also be implemented on containers that are provisioned by provisioning fabric 225. As such, master services 201 can be provisioned and destroyed by the provisioning fabric 225 as needs change (e.g., as instructed by the control service 223 and/or control plane 226).

As shown, the control service 223 can store a catalog 229. In general, catalog 229 identifies available compute pools 205, storage pools 210, and/or data pools 217, and can identify a defined set of external tables that can be queried to select/insert data. As indicated by arrows 230a and 230b, data from this catalog 229 can be replicated into each master service 201. For example, master service 201a can store a replicated catalog 229a and master service 201b can store a replicated catalog 229b. While these replicated catalogs 229a/229b could potentially include the entirety of catalog 229, in implementations they might include only portion(s) that are applicable to the corresponding master service 201. Thus, for example, catalog 229a might only include first catalog data relevant to a first vertical, and catalog 229b might only include second catalog data relevant to a second vertical. In this way, the different master services 201 are only aware of, and able to access, the various pools and nodes relevant to its external consumers.

Notably, database system 200 can be used to store various types of data, such as on-line analytical processing (OLAP) data, on-line transaction processing (OLTP) data, etc. In general, OLAP systems are characterized by relatively low volume of transactions, but in which queries are often very complex and involve aggregations, while OLTP systems are characterized by a large number of short on-line transactions (e.g., INSERT, UPDATE, DELETE), with the main emphasis being very fast query processing, maintaining data integrity in multi-access environments, and an effectiveness measured by number of transactions per second. Notably, due to their differing properties and requirements, OLAPs and OLTPs have classically been implemented as separate systems. However, in some embodiments, database system 200 brings these systems together into a single system.

For example, implementations may use a master node (e.g., master node 201a) to store (e.g., in database storage 203a) OLTP data and process OLTP queries for a vertical (e.g., due to comparatively short transaction times involved in OLTP), while using storage pools 210 and/or data pools 217 to store OLAP data and using compute pools 205 to process OLAP queries for the vertical (e.g., due to the comparative complexity of OLAP queries). Thus, database system 200 brings OLAP and OLTP together under a single umbrella for a vertical.

As shown in FIG. 2, there may be one or more duplicate (i.e., child) instances of each master service 201. For example, box 201a-n indicates that master service 201a can include one or more child instances, and box 201b-n indicates that master service 201b can include one or more child instances. In some embodiments, each of these child instances are a read-only replica of the parent master service 201. In embodiments, database system 200 might create high-availability groups for each master service 201 using these child instances. In these implementations, for example, if the relational master 201a were to go down, child instance (201a-n) could take over as the read-write master. More than that, however, in embodiments these child instances need not sit idly when they are not serving as read-write masters. Instead, they can be used to support handling of read-only queries by external consumers.

In some embodiments, the database systems 100/200 shown in FIGS. 1 and 2 can exist individually in a single cloud environment. In other embodiments, a single cloud environment could host multiple database systems 100/200. In these embodiments, each database system might be a different database cluster that is managed by a single control plane.

For example, FIG. 3 illustrates an environment 300 that manages multiple database systems across multiple clouds. For example, environment 300 includes a cloud 302a that includes a plurality of database systems 303 (shown as 303a-303n). As indicated by the ellipses 306a, cloud 302a could include any number (i.e., one or more) of database systems 303. As shown, these database systems 303 could be provisioned by a provisioning fabric 304a and managed by a control plane 301a associated with cloud 302a. Cloud 302a could be a hosted cloud (e.g., MICROSOFT AZURE, AMAZON AWS, etc.), or could be a private (e.g., on-premise) cloud.

The embodiments herein are not limited to a single cloud environment. As shown in FIG. 3, for example, environment 300 could include one or more additional clouds (as indicated by ellipses 306b), such as cloud 302n. Cloud 302n could also include multiple database managements systems 305 (shown as 305a-305n) managed by a corresponding provisioning fabric 304n and control plane 301n.

In environment 300, clouds 302 could include multiple public clouds (e.g., from different vendors or from the same vendor), multiple private clouds, and/or combinations thereof. In some embodiments, the individual database systems within these multiple clouds could be managed by a central control plane 301. In these embodiments, the central control plane 301 might be implemented in a highly available manner (e.g., by being distributed across computer systems or being replicated at redundant computer systems). When central control plane 301 exists, the individual control planes (e.g., 301a-301n) within the clouds 302 could interoperate with control plane 301 (e.g., as indicated by arrows 307a and 307b). Alternatively, the functionality of the individual control planes (e.g., 301a-301n) may be replaced by control plane 301 entirely, such that individual clouds 302 lack their own control planes. In these embodiments, the central control plane 301 may communicate directly with the provisioning fabric 304 at the clouds. Additionally, or alternatively, environment 300 might lack a central control plane 301. In these embodiments, the individual control planes (e.g., 301a-301n) might federate with one another in a peer-to-peer architecture (e.g., as indicated by arrow 307c).

In the environment 300 of FIG. 3, different database managements systems could be automatically created and/or destroyed within a cloud, similar to how pools may be created/destroyed within an individual database managements system, as described in connection with FIG. 1. The decisions as to when and where to make deployments could be made by the control plane(s) 301/301a-301n with user input, and/or could be made automatically based on rules and/or current conditions (e.g., available bandwidth, available cloud resources, estimated costs of using a given cloud, geo-political policy, etc.). The environment 300 of FIG. 3 might be viewed as a “poly-cloud” since it centralizes management of database clusters/containers across clouds.

In some embodiments, the control plane(s) 301/301a-301n provide one or more APIs that can be invoked by external tools in order to initiate any of its functions (e.g., to create and/or to destroy any of the resources described herein). These APIs could be invoked by a variety of tools, such as graphical user interfaces (GUIs), command-line tools, etc. If command-line tools are utilized, they could be useful for automating actions through the control plane's APIs (e.g., as part of a batch process or script). In some embodiments, a GUI could provide a unified user experience for database management across clouds and across database types, by interfacing with the control plane APIs.

In some embodiments, the control plane(s) 301/301a-301n provide for automating common management tasks such as monitoring, backup/restore, vulnerability scanning, performance tuning, upgrades, patching, and the like. For example, as mentioned in connection with control plane 126 of FIG. 1, the control plane(s) 301/301a-301n could provide provisioning services that handle provisioning, deprovisioning, upgrades, and configuration changes. While the discussion of control plane 126 focused on provisioning of nodes/pools within a single database system, it will be appreciated that these concepts can be extended—in view of FIG. 3—to provisioning entire database systems. The control plane(s) 301/301a-301n could also provide service-level features, such as high-availability management (e.g., among nodes/pools within a single database system, or across entire database systems), disaster recovery, backups, restoration of backups on failure, and service maintenance (e.g., performing routine database maintenance commands). The control plane(s) 301/301a-301n could also provide “bot” services that identify and mitigate against potential problems. For example, these bot services could perform cleanup tasks when low disk space is detected or anticipated. The control plane(s) 301/301a-301n could also provide alerting services, such as to notify an administrator when there are is low processing capacity, low disk space, etc.

Notably, any of the embodiments herein can greatly simplify and automate database management, including providing integrated and simplified management of security and privacy policies. For example, rather than needing to manage a plurality of individual database systems, along with their user accounts and security/privacy settings, such management is consolidated to a single infrastructure.

Some embodiments could provide a “pay-as-you-go” consumption-based billing model for using compute and storage resources within the database clusters described herein. Such functionality could be provided by individual database systems themselves, and/or could be provided by a control plane 301. In such embodiments, billing telemetry data (e.g. number of queries, query time in seconds, number of CPU seconds/minutes/hours used, etc.) could be sent to a central billing system, along with a customer identifier, to be tracked and converted into a periodic bill to the customer.

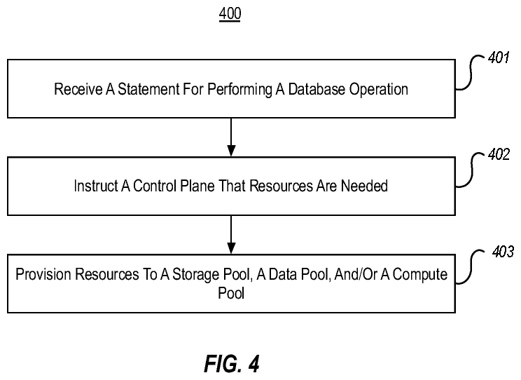

While the foregoing description has focused on example systems, embodiments herein can also include methods that are performed within those systems. FIG. 4, for example, illustrates a flow chart of an example method 400 for automatically provisioning resources within a database system. In embodiments, method 400 could be performed, for example, within database systems 100/200 of FIGS. 1 and 2, and/or within the multi-cloud environment 300 of FIG. 3. While, for efficiency, the following description focuses on database system 100 of FIG. 1, it will be appreciated that this description is equally applicable to database system 200 and environment 300.

As shown, method 400 includes an act 401 of receiving a statement for performing a database operation. In some embodiments, act 401 comprises receiving, at a master service of the database system, a declarative statement for performing a database operation. For example, master service 101 could receive a declarative statement, such as a query from an external consumer. This declarative statement could be formatted in accordance with API(s) 102. In embodiments, this declarative statement could be in the form of a traditional database query, such as a relational (e.g., SQL) query or a non-relational query. Alternatively, this declarative statement could be in the form of a big data (e.g., SPARK) query. While the declarative statement could request a database operation that interacts with one or more databases (e.g., to query data or insert data), the declarative statement could alternatively request a database operation specifically directed at modifying resource provisioning within database system 100.

Method 400 also includes an act 402 of instructing a control plane that resources are needed. In some embodiments, act 402 comprises, based on receiving the declarative statement, instructing a control plane that additional hardware resources are needed for performing the database operation. For example, the master service 101 could instruct control plane 126 that additional hardware resources are needed in view of the requested database operation. In embodiments, master service 101 could make this request to control plane directly. Alternatively, master service 101 could make this request indirectly via control service 123/deployment module 124.

Method 400 also includes an act 403 of provisioning resources to a storage pool, a data pool, and/or a compute pool. In some embodiments, act 403 comprises, based on instructing the control plane, provisioning, by a provisioning fabric, computer system hardware resources for one or more of: a storage pool that includes at least one storage node that comprises a first database engine, a big data engine, and big data storage; a data pool that includes at least one data node that comprises a second database engine and database storage; or a compute pool that includes a compute node that comprises a compute engine that processes queries at one or both of the storage pool or the data pool. For example, based on the master service 101 having instructed the control plane 126 that additional hardware resources are needed, the provisioning fabric can actually allocate those hardware resources. As discussed herein, resources might be allocated to storage pools 110, compute pools 105 and/or data pools 117.

Accordingly, act 403 could include the provisioning fabric provisioning computer system hardware resources for the storage pool 110a, such as by instantiating storage node 111a. As discussed, storage node 111a can include a traditional database engine 112a (e.g., a relational database engine, or a non-relational database engine), a big data engine 113a, and big data storage 114a

Act 403 could additionally, or alternatively, include the provisioning fabric provisioning computer system hardware resources for the data pool 117a, such as by instantiating data node 118a. As discussed, data node 118a can include a traditional database engine 119a (e.g., a relational database engine or a non-relational database engine) and traditional database storage 120a (e.g., relational database storage or non-relational database storage).

Act 403 could additionally, or alternatively, include the provisioning fabric provisioning computer system hardware resources for the compute pool 105a, such as by instantiation compute node 106a. As discussed, compute node 106a can include a compute engine 107a for processing queries across combinations of the storage pool 110a, the data pool 117a and/or database storage 103 at the master service 101.

As was noted in connection with FIG. 3, a control plane can manage multiple database systems within a single cloud, and/or can operate with other control planes to manage multiple database systems across multiple clouds. Thus, method 400 can include the control plane communicating with one or more other control planes to monitor and manage a plurality of database systems across a plurality of computer systems.

As was discussed in connection with FIG. 2, a database system 200 can include multiple master services 201. As such, in method 400, wherein the database system could include a plurality of master services. As was also discussed in connection with FIG. 2, each master services 201 could potentially include one or more read-only children (e.g., 201a-n, 201b-n). As such, in method 400, the master service(s) could include one or more read-only children. Regardless, of whether there is a single maser service or multiple master services, method 400 could include the provisioning fabric provisioning computer system hardware resources for a master service.

As was discussed in connection with FIG. 1, each provisioned node could include software level agents (e.g., 115, 108, and 121) and software host level agents (e.g., 116, 109, and 122) that communicate with the control plane 126. Thus, in method 400 a provisioned storage node, data node, and/or compute node could each include a corresponding agent that communicates with the control plane. Additionally, when provisioning computer system hardware resources in act 403, the provisioning fabric 125 could provision hardware resources to at least one of a virtual machine, a jail, or a container.

Accordingly, the embodiments described herein can automate deployment of nodes (and pools of nodes) within a unified database management system, making growing and shrinking compute and storage resources transparent to the database consumer. This unified database management system can be extended to multiple database clusters/containers within the same cloud, and/or or can be extended to across multiple clouds (both public and private). When extended across clouds, a single control plane can manage the entire system, greatly simplifying database system management, and providing a single location to manage security and privacy.

It will be appreciated that embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “MC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer-readable media having stored thereon computer-executable instructions, that when executed at the one or more processors, cause the computer system to perform the following:
receive, at a master service of a database system, a declarative statement for performing a database operation;
based on receiving the declarative statement, instruct a control plane that additional hardware resources are needed for performing the database operation; and
based on instructing the control plane, provision, by a provisioning fabric, computer system hardware resources for one or more of:
a storage pool that includes at least one storage node that comprises a first database engine, a big data engine, and big data storage;
a data pool that includes at least one data node that comprises a second database engine and database storage; or
a compute pool that includes a compute node that comprises a compute engine that processes queries at one or both of the storage pool or the data pool.

2. The computer system as recited in claim 1, wherein the control plane monitors and manages a plurality of database systems at the computer system.

3. The computer system as recited in claim 1, wherein the control plane communicates with one or more other control planes to monitor and manage a plurality of database systems across a plurality of computer systems.

4. The computer system as recited in claim 1, wherein the database system includes one or more read-only children of the master service.

5. The computer system as recited in claim 1, wherein the database system includes a plurality of master services.

6. The computer system as recited in claim 1, wherein the provisioning fabric provisions computer system hardware resources for the master service.

7. The computer system as recited in claim 1, wherein the master service exposes one or more database engine application programming interfaces (APIs) and one or more big data engine APIs.

8. The computer system as recited in claim 7, wherein the one or more database engine APIs comprise relational database APIs, and wherein the declarative statement comprises a relational database query.

9. The computer system as recited in claim 1, wherein the provisioning fabric provisions computer system hardware resources for the storage pool, and wherein the first database engine comprises a relational database engine.

10. The computer system as recited in claim 1, wherein the provisioning fabric provisions computer system hardware resources for the data pool, and wherein the second database engine comprises a relational database engine and the database storage comprises relational database storage.

11. The computer system as recited in claim 1, wherein the provisioning fabric provisions computer system hardware resources for the compute pool.

12. The computer system as recited in claim 1, wherein the storage node, the data node, and the compute node each includes a corresponding agent that communicates with the control plane.

13. The computer system as recited in claim 1, wherein provisioning computer system hardware resources comprises provisioning hardware resources to at least one of a virtual machine, a jail, or a container.

14. A method, implemented at a computer system that includes one or more processors, for automatically provisioning resources within a database system, the method comprising:
receiving, at a master service of the database system, a declarative statement for performing a database operation;
based on receiving the declarative statement, instructing a control plane that additional hardware resources are needed for performing the database operation; and
based on instructing the control plane, provisioning, by a provisioning fabric, computer system hardware resources for one or more of:
a storage pool that includes at least one storage node that comprises a first database engine, a big data engine, and big data storage;
a data pool that includes at least one data node that comprises a second database engine and database storage; or
a compute pool that includes a compute node that comprises a compute engine that processes queries at one or both of the storage pool or the data pool.

15. The method of claim 14, wherein the control plane monitors and manages a plurality of database systems at the computer system, and also communicates with one or more other control planes to monitor and manage a plurality of database systems across a plurality of computer systems.

16. The method of claim 14, wherein the database system includes a plurality of master services, and wherein the provisioning fabric provisions computer system hardware resources for each of the plurality of master services.

17. The method of claim 14, wherein the provisioning fabric provisions computer system hardware resources for the storage pool, and wherein the first database engine comprises a relational database engine.

18. The method of claim 14, wherein the provisioning fabric provisions computer system hardware resources for the data pool, and wherein the second database engine comprises a relational database engine and the database storage comprises relational database storage.

19. The method of claim 14, wherein the provisioning fabric provisions computer system hardware resources for the compute pool.

20. A computer program product comprising hardware storage devices having stored thereon computer-executable instructions, that when executed at one or more processors, cause a computer system to perform the following:
receive, at a master service of a database system, a declarative statement for performing a database operation.
based on receiving the declarative statement, instruct a control plane that additional hardware resources are needed for performing the database operation; and
based on instructing the control plane, provision, by a provisioning fabric, computer system hardware resources for one or more of:
a storage pool that includes at least one storage node that comprises a first database engine, a big data engine, and big data storage;
a data pool that includes at least one data node that comprises a second database engine and database storage; or
a compute pool that includes a compute node that comprises a compute engine that processes queries at one or both of the storage pool or the data pool.
